(19) United States
(12) Patent Application Publication
(10) Pub. No.: US 2018/0355920 A1
(43) Pub. Date: Dec. 13, 2018

(54) Disc Coupling

(71) Applicant: Ameridrives International LLC, Erie, PA (US)

(72) Inventors: Mark Alfred O'Neil, Erie, PA (US); Troy Don Lumpkin, New Braunfels, TX (US)

(21) Appl. No.: 15/621,044

(22) Filed: Jun. 13, 2017

(51) Int. Cl. F16D 3/78; F16D 55/22; F16D 65/18; F16D 65/66

(52) U.S. Cl. CPC F16D 3/78; F16D 55/22; F16D 2125/40; F16D 65/66; F16D 65/18

(57) ABSTRACT

A disc coupling includes a spacer and discs coupled to opposite ends of the spacer. Each of the discs includes an annular body defining a plurality of circumferentially spaced fastener holes and a plurality of links with each link extending between a pair of the fastener holes. The disc further includes a washer defining a bore aligned with one of the fastener holes. The washer includes one face facing the body and another face facing away from the body and a plurality of surfaces extending between the faces. The surfaces include radially outer and inner surfaces and side surfaces extending between the radially inner and outer surfaces and defining vertices at intersections with the radially inner and outer surfaces.

### BACKGROUND OF THE INVENTION

### a. Field of the Invention

This disclosure relates to a disc coupling. In particular, the disclosure relates to a disc coupling having discs with washers that are configured to reduce stress on, and improve the life of, the body of the disc.

### b. Background Art

A disc coupling transmits torque between two shafts or other rotating bodies while also accommodating axial and angular misalignment between the bodies. A conventional disc coupling includes one or more discs that are coupled to attachment flanges mounted on, or extending from, the rotating bodies. In some disc couplings, a spacer may extend between the rotating bodies and a disc is coupled to each end of the spacer and to a corresponding body. Each disc includes a body having a plurality of circumferentially spaced bolt holes. Half of the bolt holes (every other bolt hole) receive fasteners coupling the disc to the spacer while the other half of the bolt holes (again, every other bolt hole) receive fasteners coupling the disc to one of the rotating bodies. Washers are disposed about the fasteners on either side of the disc. When there is misalignment between the rotating bodies, the body of the disc flexes and must bend around the washers. When the degree of misalignment is relatively high, significant stress is created in areas of the disc near the washers and surrounding the fasteners. This stress can ultimately result in failure of the coupling thereby limiting the life of the coupling.

The inventors herein have recognized a need for a disc coupling and a disc for a disc coupling that will minimize and/or eliminate one or more of the above-identified deficiencies.

### BRIEF SUMMARY OF THE INVENTION

This disclosure relates to a disc coupling. In particular, the disclosure relates to a disc coupling having discs with washers that are configured to reduce stress on, and improve the life of, the body of the disc.

A disc for a disc coupling in accordance with one embodiment includes an annular body defining a plurality of circumferentially spaced fastener holes and a plurality of links. Each link of the plurality of links extends between a pair of the plurality of circumferentially spaced fastener holes. The disc further includes a washer defining a bore aligned with one of the plurality of circumferentially spaced fastener holes. The washer includes a first face facing the body and a second face facing away from the body and a plurality of surfaces extending between the first and second faces. The plurality of surfaces includes a radially outer surface, a radially inner surface, and first and second side surfaces extending between the radially inner and outer surfaces and defining vertices at intersections with the radially inner and outer surfaces.

A disc coupling in accordance with one embodiment includes a spacer and first and second discs coupled to opposite ends of the spacer. Each of the first and second discs includes an annular body defining a plurality of circumferentially spaced fastener holes and a plurality of links. Each link of the plurality of links extends between a pair of the plurality of circumferentially spaced fastener holes. The disc further includes a washer defining a bore aligned with one of the plurality of circumferentially spaced fastener holes. The washer includes a first face facing the body and a second face facing away from the body and a plurality of surfaces extending between the first and second faces. The plurality of surfaces includes a radially outer surface, a radially inner surface, and first and second side surfaces extending between the radially inner and outer surfaces and defining vertices at intersections with the radially inner and outer surfaces.

A disc coupling and disc for the disc coupling in accordance with the present teachings are advantageous relative to conventional disc couplings and discs. In particular, the configuration of the washer significantly reduces stress on the body of the disc that occurs during misalignment of the rotating bodies attached to the coupling by better distributing the stress on the body of the disc. As a result, the disc is less likely to fail and the life of the disc and coupling are improved.

The foregoing and other aspects, features, details, utilities, and advantages of the invention will be apparent from reading the following detailed description and claims, and from reviewing the accompanying drawings illustrating features of this invention by way of example.

### BRIEF DESCRIPTION OF THE DRAWINGS

FIG. 1 is an end view of a disc coupling in accordance with one embodiment of the present teachings.

FIG. 2 is cross-sectional view of the disc coupling of FIG. 1 taken along lines 2-2 in FIG. 1.

FIG. 3 is a perspective view of a disc for a disc coupling in accordance with one embodiment of the present teachings.

FIG. 4 is an end view of the disc of FIG. 3.

FIG. 5 is a cross-sectional view of the disc of FIGS. 3-4 taken along lines 5-5 in FIG. 4.

FIG. 6 is an end view of one embodiment of a washer of the disc of FIGS. 3-5.

FIG. 7 is a cross-sectional view of the washer of FIG. 6 taken along lines 7-7 in FIG. 6.

FIG. 8 is a perspective view of the washer of FIGS. 6-7.

FIG. 9 is an end view of another embodiment of a washer of the disc of FIGS. 3-5.

FIG. 10 is a cross-sectional view of the washer of FIG. 9 taken along lines 10-10 in FIG. 9.

FIG. 11 is a cross-sectional view of the disc coupling in accordance with another embodiment of the present teachings.

FIG. 12 is an end view of another embodiment of a washer of the disc of FIGS. 3-5.

FIG. 13 is a cross-sectional view of the washer of FIG. 12 taken along lines 13-13 in FIG. 12.

FIG. 14 is an end view of another embodiment of a washer of the disc of FIGS. 3-5.

FIG. 15 is a cross-sectional view of the washer of FIG. 14 taken along lines 15-15 in FIG. 14.

FIG. 16 is perspective view of a portion of a disc for a disc coupling in accordance with another embodiment of the present teachings.

FIG. 17 is an end view of another embodiment of a washer of the disc of FIGS. 3-5.

FIG. 18 is a cross-sectional view of the washer of FIG. 17 taken along lines 18-18 in FIG. 17.

FIG. 19 is an end view of another embodiment of a washer of the disc of FIGS. 3-5.

FIG. 20 is a cross-sectional view of the washer of FIG. 19 taken along lines 20-20 in FIG. 19.

### DETAILED DESCRIPTION OF THE INVENTION

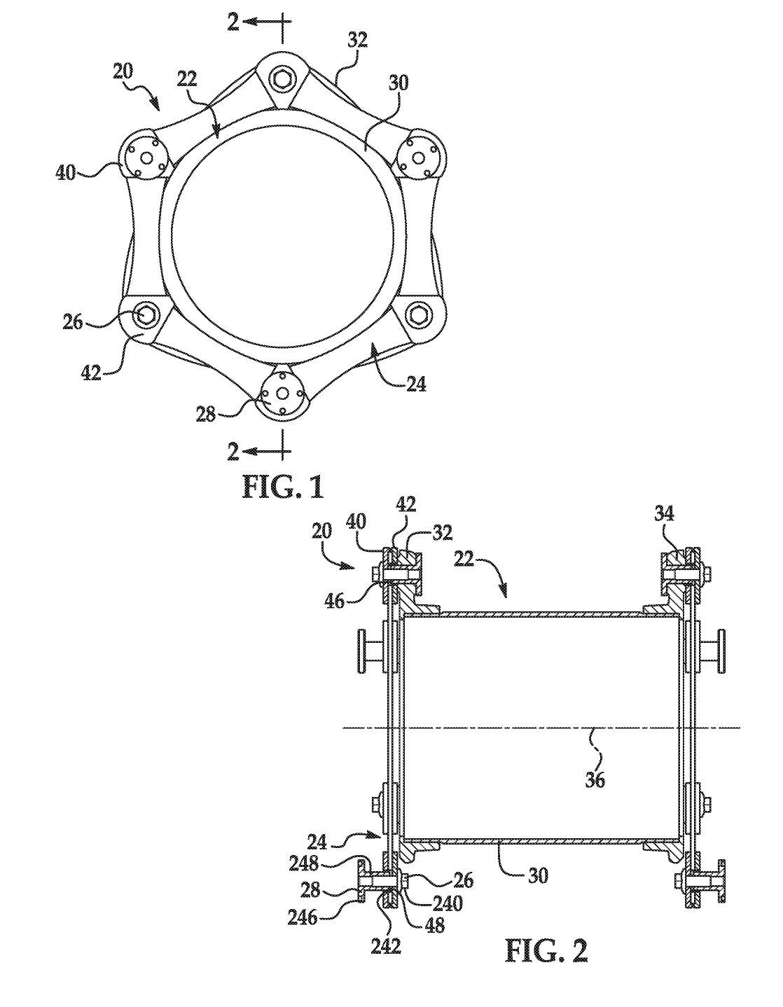

Referring now to the drawings wherein like reference numerals are used to identify identical components in the various views, FIGS. 1-2 illustrate a disc coupling 20 in accordance with one embodiment of the present teachings. Coupling 20 is provided to couple driving and driven rotating bodies in a power transmission assembly such as a drive shaft from a motor or other power source and a driven shaft used to rotate a component such as a pump or gear. Coupling 20 transmits torque between the bodies while also permitting axial and angular misalignment between the bodies. Coupling 20 includes a spacer 22, discs 24 disposed at each end of spacer 22 and cooperating fasteners 26, 28.

Spacer 22 is provided to bridge a space between the rotating bodies and to transmit torque between the bodies. Spacer 22 includes a tubular body 30 and attachment flanges 32, 34 disposed at either end of body 30. In the illustrated embodiment, attachment flanges 32, 34 are separate structures relative to body 30. It should be understood, however, that the body 30 and flanges 32, 34 may be unitary (one-piece) structure. Body 30 may be made from a variety of materials including conventional metals, metal alloys and polymers. Body 30 may be disposed about, and centered about, an axis 36. Body 30 may be sized to receive portions of hubs (not shown) at each end of body 30 that are coupled to the rotating bodies and to discs 24 of coupling 20. In the illustrated embodiment, body 30 is a unitary (one-piece) structure. It should be understood, however, that body 30 may alternatively be formed from multiple joined structures to allow coupling 20 to be used over varying distances between rotating bodies. Flanges 32, 34 couple spacer 22 to discs 24. Flanges 32, 34 may be made from aluminum or other conventional metals and metal alloys and may be secured to body 30 using conventional fastening techniques including adhesives or welds. Each flange 32, 34 extends radially outwardly from body 30 and defines a plurality of fastener bores that are configured to receive fasteners 26, 28 extending through corresponding discs 24 and coupling flanges 32, 34 to discs 24.

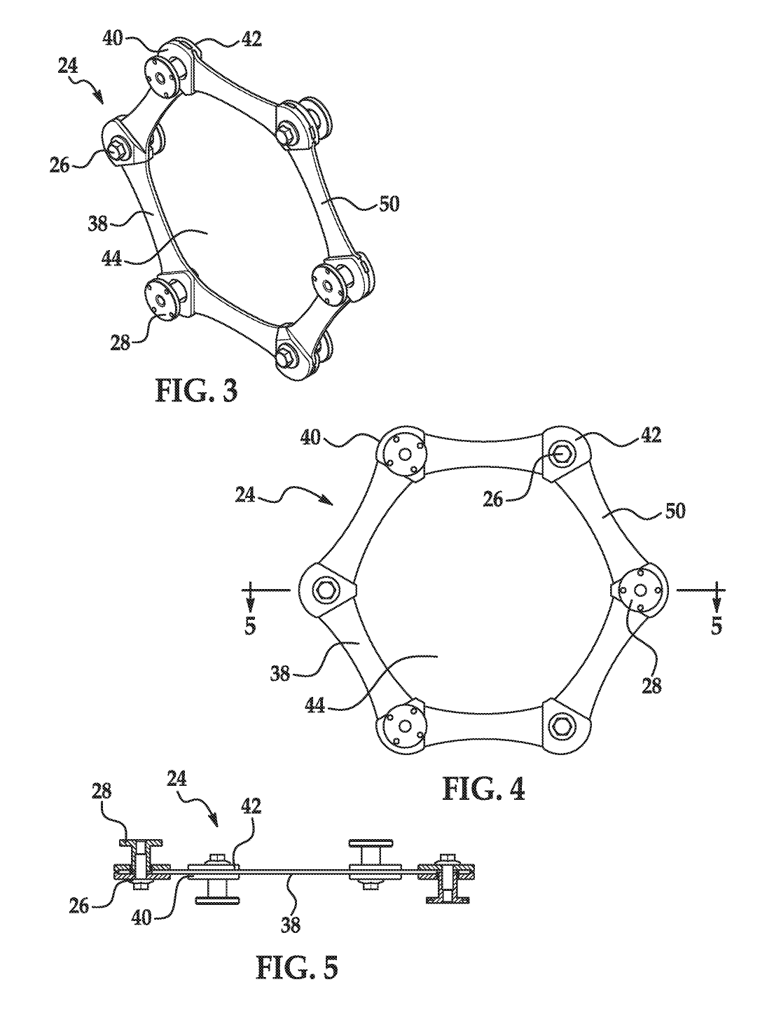

Discs 24 are provided to transmit torque between one of the rotating bodies and spacer 22 and to flex and bend to accommodate axial and angular misalignment between the rotating bodies. Referring to FIGS. 3-5, each disc includes an annular body 38 and a plurality of washers 40, 42.

Body 38 may be made from various metals and metal alloys. Body 38 is annular in shape, defining a central bore 44 that may be disposed about, and centered about axis 36, upon assembly with spacer 22. Like body 30 of spacer 22, bore 44 of body 38 may be sized to receive a portion of a hub (not shown) that is coupled to a rotating body. Referring again to FIG. 2, body 38 defines a plurality of circumferentially spaced fastener holes 46, 48 configured to receive fasteners 26, 28. One group of the fastener holes 46 is configured to receive fasteners 26, 28 used to couple disc 24 to spacer 22 (and, in particular to one of attachment flanges 32, 34 of spacer 22) disposed on one side of disc 24. Another group of fastener holes 48 is configured to receive fasteners 26, 28 used to couple disc 24 to one of the rotating bodies (e.g., by attachment to radially extending mounting flanges of a hub coupled to or extending from the rotating body) disposed on an opposite side of the disc 24 relative to spacer 22. The two groups of fastener holes 46, 48 alternate about the circumference of body 38 such that each fastener hole 46 in the group of fastener holes used in coupling disc 24 to spacer 22 is disposed circumferentially between a pair of fastener holes 48 used in coupling disc 24 to one of the rotating bodies and each fastener hole 48 in the group of fastener holes used in coupling disc 24 to a rotating body is disposed circumferentially between a pair of fastener holes 46 used in coupling disc 24 to spacer 22. Referring again to FIGS. 3-5, body 38 further defines a plurality of links 50 extending between fastener holes 46, 48. Each link 50 extends between a fastener hole 46 and a fastener hole 48. In the illustrated embodiment, links 50 are scalloped such that the radially outer surface of each link 50 is concave in shape. It should be understood, however, that the shape of links 50 may vary and, in particular, that the radially outer surface may be straight or round in some embodiments. Depending on the direction of rotation, one half of the links 50 (every other link in the circumferential direction) act in tension to transmit torque between spacer 22 and one of the rotating bodies. The other half of the links act in compression.

Washers 40, 42 are provided to distribute forces between the body 38 of disc 24 and the fasteners 26, 28. Washers 40, 42 may be made from conventional metals and metal alloys. In accordance with the present teachings, washers 40, 42 are configured to better distribute forces along body 38, thereby reducing stress on body 38 and improving the life of disc 24. Conventional designs for disc couplings employ round washers. The inventors have determined, however, that significant stress arises in areas where the body 38 of discs 24 flexes and bends around the washers during periods of misalignment between the rotating bodies. The inventors have further determined that the washers can be configured in various ways to better distribute forces imparted to the body 38 of disc 24 and thereby reduce the stress on body 38.

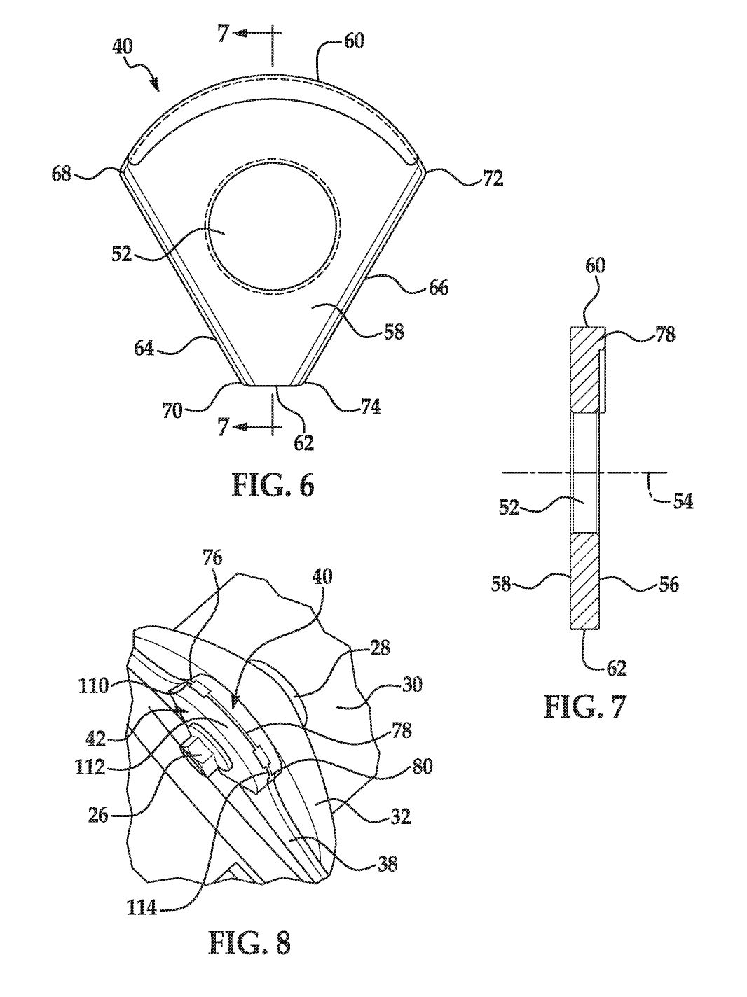

Referring now to FIGS. 6-7, washer 40 defines a bore 52 that is configured for alignment with one of fasteners holes 46, 48. Bore 52 is disposed about an axis 54 that may extend substantially parallel to axis 36 upon assembly of coupling 20. Bore 52 is sized to receive fasteners 26, 28 therein along with a portion of washer 42 as described in greater detail below. Washer 40 includes one axial end face 56 that faces towards body 38 of disc 24 and another axial end face 58 that faces away from body 38. Washer 40 further includes a plurality of surfaces 60, 62, 64, 66 that extend between faces 52, 54 in directions substantially parallel to axis 54 and that are configured such that the width of washer 40 tapers moving from radially outer surface 60 to radially inner surface 62. Radially outer surface 60 may be curved and, in particular, convex. Radially inner surface 62 may be flat or substantially flat. It should be understood, however, that the shape of surfaces 60, 62 may vary. Side (or circumferential) surfaces 64, 66 extend between surfaces 60, 62 and define vertices 68, 70 and 72, 74, respectively, at the points of intersection with surfaces 60, 62. Surfaces 64, 66 may be flat or substantially flat such that surfaces 64, 66 diverge away from one another at a constant rate moving from surface 62 towards surface 60. The inventors have determined that the shape of washer 40 and, in particular, the use of flat or substantially flat side surfaces 64, 66 distributes the forces transmitted through fasteners 26, 28 to body 38 of disc 24 over a larger area thereby reducing stress on body 38 proximate washers 40 and improving the life of disc 24. Referring to FIGS. 7-8, washer 40 may include means, such as one or more fingers 76, 78, 80, for inhibiting rotation of washer 40 about axis 54. Fingers 76, 78, 80 extend axially from face 52 of washer 40. Fingers 76, 78, 80 are disposed radially outwardly of body 38 of disc 24 and are radially aligned with body 38. As a result, the orientation of washer 40 is maintained despite torque imparted to washer 40 during operation of coupling 20. Referring to FIG. 8, the circumferential length of fingers 76, 78, 80 may vary. In the illustrated embodiment, finger 78 has a greater circumferential length than fingers 76, 80 and is disposed between fingers 76, 80 in the circumferential direction. Fingers 76, 80 may have the same circumferential length. As an alternative to fingers 76, 78, 80, other means for inhibiting rotation of washer 40 about axis 54 may include fingers that are located on surface 62 of washer 40 and that are disposed radially inwardly of body 38 of disc 24 and aligned with body 38 of disc 24, a fastener (e.g., a pin) extending through washer 40 and disc 24, and a projection extending from one of disc 24 and washer 40 into a hole formed in the other of disc 24 and washer 40 wherein the projection and hole have complementary shapes that inhibit rotation (e.g., splines, a key/keyway or a D-shaped projection/hole).

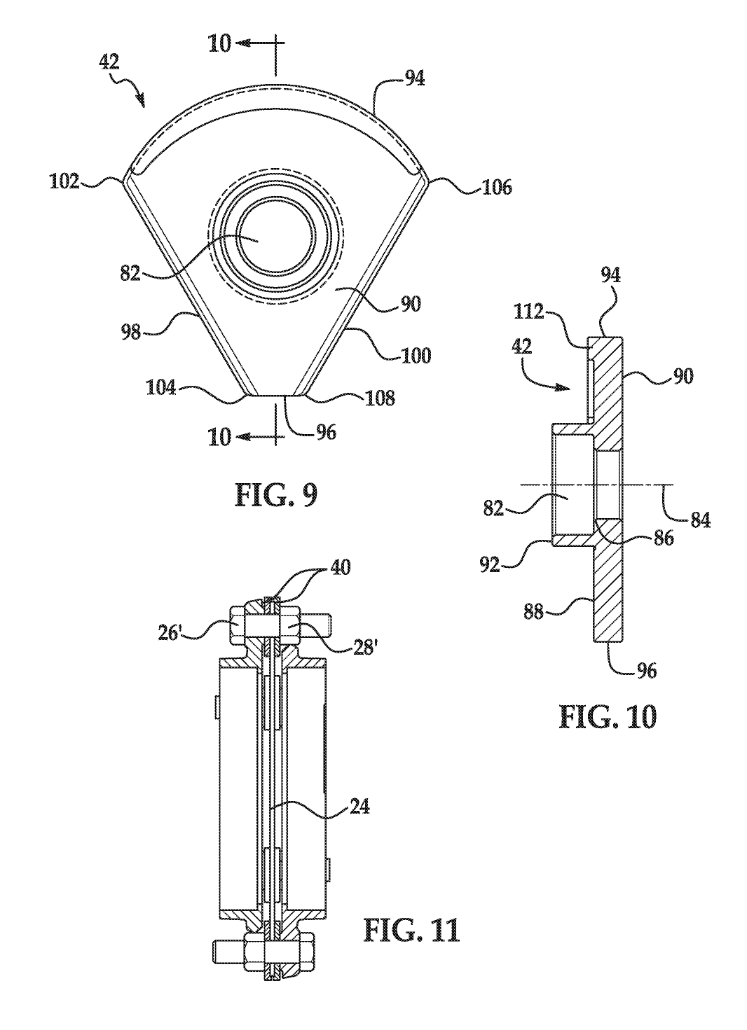

Referring now to FIGS. 9-10, washer 42 is configured for use with washer 40 as a mating set of washers. In the illustrated embodiment, washers 40, 42 are different from one another and configured to receive fasteners 26, 28 having a particular configuration. Referring to FIG. 11, in an alternative embodiment, two identical washers, such as washers 40, may be used in situations where other types of fasteners, such as fasteners 26′, 28′, are used to couple disc 24 to surrounding structures such as the attachment flanges for rotating bodies and/or spacers. Referring to FIG. 2, washer 42 is disposed on an opposite side of body 38 of disc 24 relative to washer 40 and is aligned with washer 40. Washers 40, 42 receive a corresponding set of fasteners 26, 28. Washers 40, 42 alternate on each side of body 38 moving in a circumferential direction such that, on each side of body 38, each washer 40 is disposed circumferentially between two washers 42 and each washer 42 is disposed circumferentially between two washers 40. Referring again to FIGS. 9-10, washer 42 defines a bore 82 that is configured for alignment with one of fasteners holes 46, 48 and a corresponding bore 52 in washer 40. Bore 82 is disposed about an axis 84 that may extend substantially parallel to axis 36 upon assembly of coupling 20 and may be coincident with axis 54 upon assembly of coupling 20. Bore 82 is sized to receive fasteners 26, 28 therein. The inner diameter of bore 82 may vary to define a shoulder 86. Washer 42 includes one axial end face 88 that faces towards body 38 of disc 24 and another axial end face 90 that faces away from body 38. Washer 42 further defines an annular projection 92 extending from face 88 that is configured to extend through one of fastener holes 46, 48 and into bore 52 on washer 40. Washer 42 further includes a plurality of surfaces 94, 96, 98, 100 that extend between faces 88, 90 in directions substantially parallel to axis 84 and that are configured such that the width of washer 42 tapers moving from radially outer surface 94 to radially inner surface 96. Radially outer surface 94 may be curved and, in particular, convex. Radially inner surface 96 may be flat or substantially flat. It should be understood, however, that the shape of surfaces 60, 62 may vary. Side (or circumferential) surfaces 98, 100 extend between surfaces 94, 96 and define vertices 102, 104 and 106, 108, respectively, at the points of intersection with surfaces 94, 96. Surfaces 98, 100 may be flat or substantially flat such that surfaces 98, 100 diverge away from one another at a constant rate moving from surface 96 towards surface 94. Referring to FIGS. 8 and 10, washer 42 may again include means, such as one or more fingers 110, 112, 114, for inhibiting rotation of washer 42 about axis 84. Fingers 110, 112, 114 extend axially from face 88 of washer 42. Fingers 110, 112, 114 are disposed radially outwardly of body 38 of disc 24 and are radially aligned with body 38. As a result, the orientation of washer 42 is maintained despite torque imparted to washer 42 during operation of coupling 20. Referring to FIG. 8, the circumferential length of fingers 110, 112, 114 may vary. In the illustrated embodiment, finger 112 has a greater circumferential length than fingers 110, 114 and is disposed between fingers 110, 114 in the circumferential direction. Fingers 110, 114 may have the same circumferential length. As an alternative to fingers 110, 112, 114, other means for inhibiting rotation of washer 42 about axis 84 may again include fingers that are located on surface 96 of washer 42 and that are disposed radially inwardly of body 38 of disc 24 and aligned with body 38 of disc 24, a fastener (e.g., a pin) extending through washer 42 and disc 24, and a projection extending from one of disc 24 and washer 42 into a hole formed in the other of disc 24 and washer 42 wherein the projection and hole have complementary shapes that inhibit rotation (e.g., splines, a key/keyway or a D-shaped projection/hole).

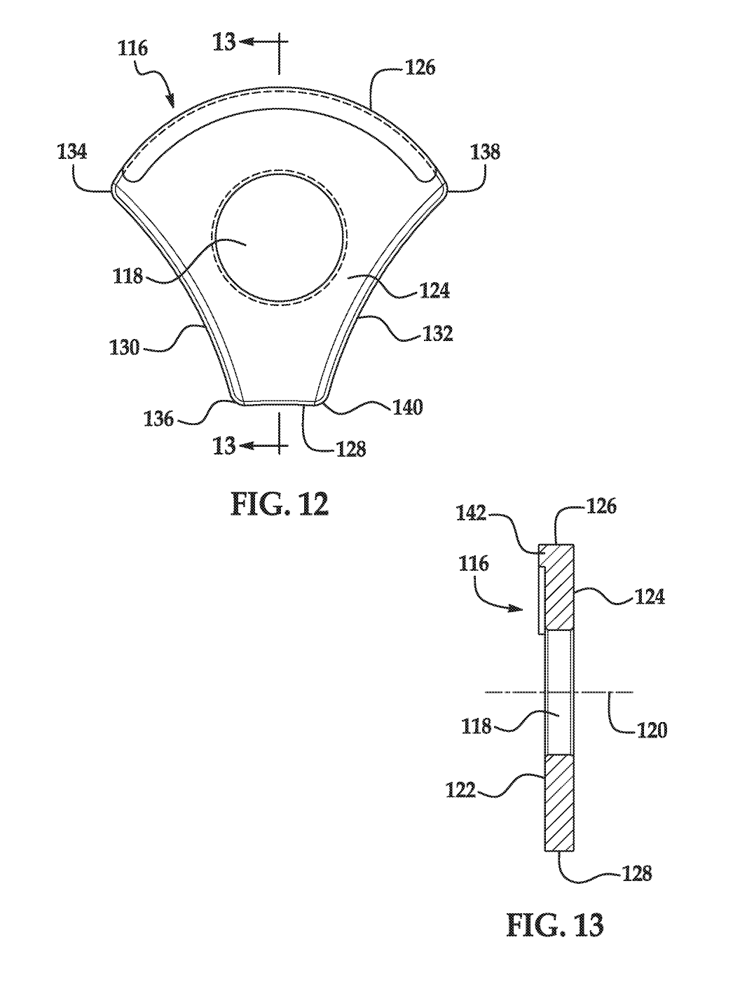

Referring now to FIGS. 12-13 another embodiment of a washer 116 is shown. Washer 116 defines a bore 118 that is configured for alignment with one of fasteners holes 46, 48. Bore 118 is disposed about an axis 120 that may extend substantially parallel to axis 36 upon assembly of coupling 20. Bore 118 is sized to receive fasteners 26, 28 therein along with a portion of another washer described in greater detail below. Washer 116 includes one axial end face 122 that faces towards body 38 of disc 24 and another axial end face 124 that faces away from body 38. Washer 116 further includes a plurality of surfaces 126, 128, 130, 132 that extend between faces 122, 124 in directions substantially parallel to axis 120 and that are configured such that the width of washer 116 tapers moving from radially outer surface 126 to radially inner surface 128. Radially outer surface 126 may be curved and, in particular, convex. Radially inner surface 128 may be flat or substantially flat. It should be understood, however, that the shape of surfaces 126, 128 may vary. Side (or circumferential) surfaces 130, 132 extend between surfaces 126, 128 and define vertices 134, 136 and 138, 140, respectively, at the points of intersection with surfaces 126, 128. Surfaces 130, 132 may be curved. In particular, surfaces 130, 132 may be concave and, in some embodiments, parabolic such that surfaces 130, 132 diverge away from one another at an increasing rate moving from surface 128 towards surface 126. The inventors have determined that the use of side surfaces 130, 132 reduces the stress on body 38 proximate washers 40 even further relative to washer 40. Washer 116 may also include means, such as one or more fingers 142, for inhibiting rotation of washer 116 about axis 120. Fingers 142 extend axially from face 122 of washer 116. The fingers 142 may be similar in shape and arrangement to the fingers on washer 40 described above. As an alternative to fingers 142, other means for inhibiting rotation of washer 116 about axis 120 may again include fingers that are located on surface 128 of washer 116 and that are disposed radially inwardly of body 38 of disc 24 and aligned with body 38 of disc 24, a fastener (e.g., a pin) extending through washer 116 and disc 24, and a projection extending from one of disc 24 and washer 116 into a hole formed in the other of disc 24 and washer 116 wherein the projection and hole have complementary shapes that inhibit rotation (e.g., splines, a key/keyway or a D-shaped projection/hole).

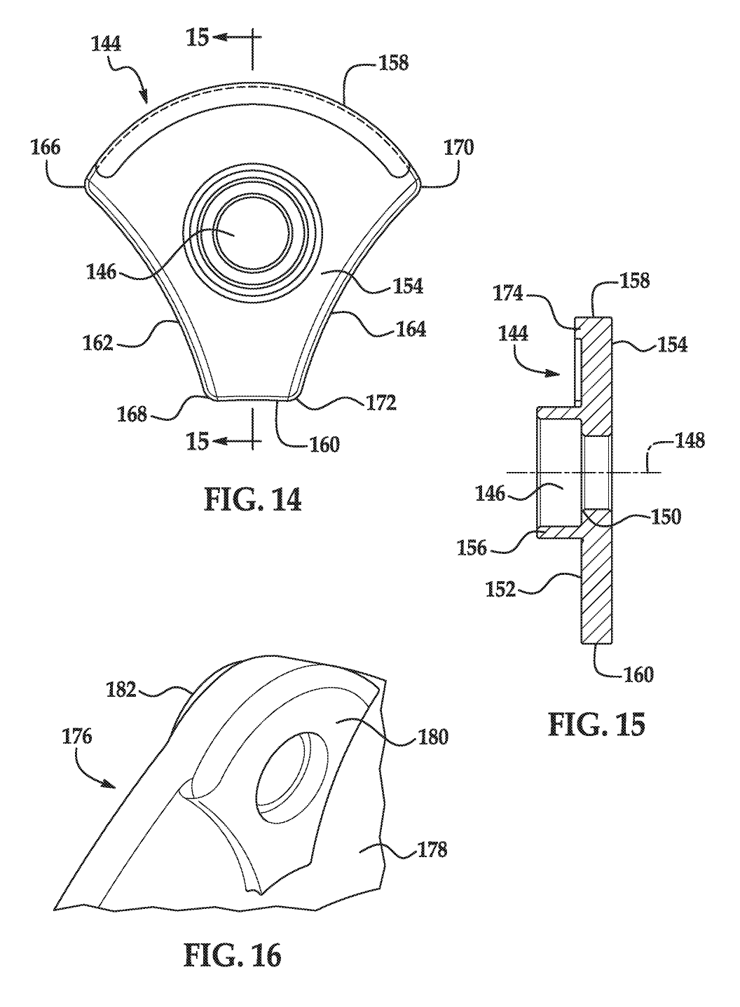

Referring now to FIGS. 14-15, washer 144 is configured for use with washer 116 as a mating set of washers. Washer 144 is disposed on an opposite side of body 38 of disc 24 relative to washer 116 and is aligned with washer 116. Washers 116, 144 receive a corresponding set of fasteners 26, 28. Washers 116, 144 alternate on each side of body 38 moving in a circumferential direction such that, on each side of body 38, each washer 116 is disposed circumferentially between two washers 144 and each washer 144 is disposed circumferentially between two washers 116. Washer 144 defines a bore 146 that is configured for alignment with one of fasteners holes 46, 48 and a corresponding bore 118 in washer 116. Bore 146 is disposed about an axis 148 that may extend substantially parallel to axis 36 upon assembly of coupling 20 and may be coincident with axis 120 upon assembly of coupling 20. Bore 146 is sized to receive fasteners 26, 28 therein. The inner diameter of bore 146 may vary to define a shoulder 150. Washer 144 includes one axial end face 152 that faces towards body 38 of disc 24 and another axial end face 154 that faces away from body 38. Washer 144 further defines an annular projection 156 extending from face 152 that is configured to extend through one of fastener holes 46, 48 and into bore 118 on washer 116. Washer 144 further includes a plurality of surfaces 158, 160, 162, 164 that extend between faces 152, 154 in directions substantially parallel to axis 148 and that are configured such that the width of washer 144 tapers moving from radially outer surface 158 to radially inner surface 160. Radially outer surface 158 may be curved and, in particular, convex. Radially inner surface 160 may be flat or substantially flat. It should be understood, however, that the shape of surfaces 158, 160 may vary. Side (or circumferential) surfaces 162, 164 extend between surfaces 158, 160 and define vertices 166, 168 and 170, 172, respectively, at the points of intersection with surfaces 158, 160. Surfaces 162, 164 may be curved. In particular, surfaces 162, 164 may be concave and, in some embodiments, parabolic such that surfaces 162, 164 diverge away from one another at an increasing rate moving from surface 160 towards surface 158. Washer 144 may also include means, such as one or more fingers 174, for inhibiting rotation of washer 144 about axis 148. Fingers 174 extend axially from face 152 of washer 144. The fingers 174 may be similar in shape and arrangement to the fingers on washer 42 described above. As an alternative to fingers 174, other means for inhibiting rotation of washer 144 about axis 148 may again fingers that are located on surface 160 of washer 144 and that are disposed radially inwardly of body 38 of disc 24 and aligned with body 38 of disc 24, a fastener (e.g., a pin) extending through washer 144 and disc 24, and a projection extending from one of disc 24 and washer 144 into a hole formed in the other of disc 24 and washer 144 wherein the projection and hole have complementary shapes that inhibit rotation (e.g., splines, a key/keyway or a D-shaped projection/hole).

Referring now to FIG. 16, another embodiment of a disc 176 for a disc coupling is shown. Disc 176 may be substantially similar to disc 24 discussed hereinabove except that the body 178 of disc 176 and the washers 180, 182 aligned with each fastener hole may be formed as unitary (one-piece) structure such that washers 180, 182 are formed as bosses extending from body 178. Washers 180, 182 may be substantially similar to any of washers 40, 42, 116, 144 discussed hereinabove except that washers 180, 182 do not require any means for inhibiting rotation of washers 180, 182 about the axis of the washer bore.

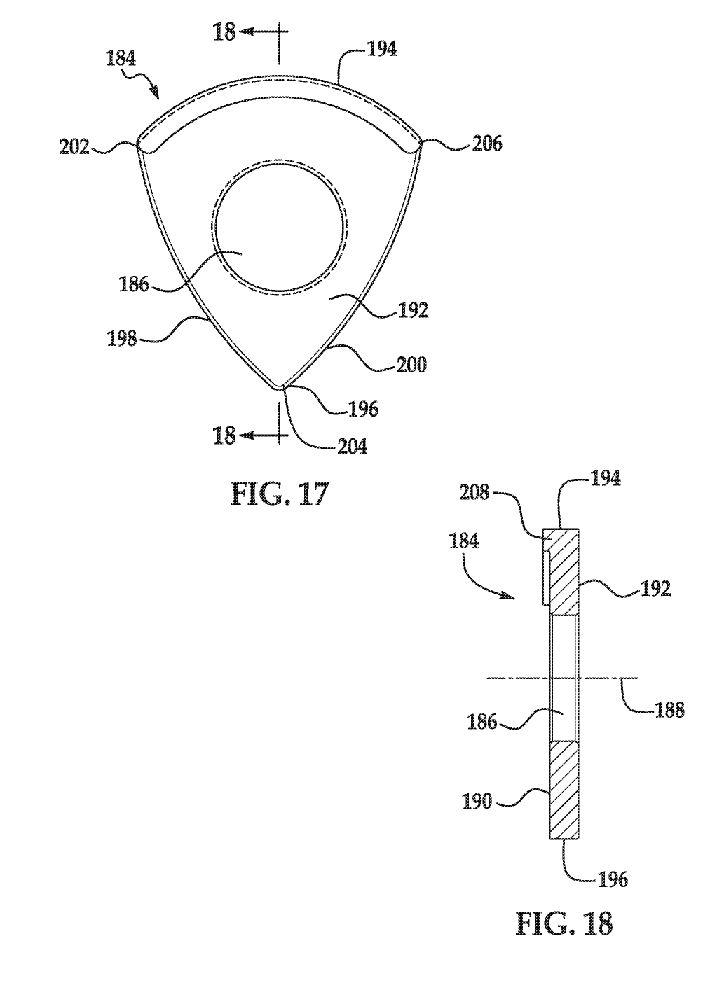

Referring now to FIGS. 17-18 another embodiment of a washer 184 is shown. Washer 184 defines a bore 186 that is configured for alignment with one of fasteners holes 46, 48. Bore 186 is disposed about an axis 188 that may extend substantially parallel to axis 36 upon assembly of coupling 20. Bore 186 is sized to receive fasteners 26, 28 therein along with a portion of another washer described in greater detail below. Washer 184 includes one axial end face 190 that faces towards body 38 of disc 24 and another axial end face 192 that faces away from body 38. Washer 184 further includes a plurality of surfaces 194, 196, 198, 200 that extend between faces 190, 192 in directions substantially parallel to axis 188 and that are configured such that the width of washer 184 tapers moving from radially outer surface 194 to radially inner surface 196. Radially outer surface 194 may be curved and, in particular, convex. Radially inner surface 196 may be flat or substantially flat. It should be understood, however, that the shape of surfaces 194, 196 may vary. Side (or circumferential) surfaces 198, 200 extend between surfaces 194, 196 and define vertices 202, 204 and 206, 204, respectively, at the points of intersection with surfaces 194, 196. Surfaces 198, 200 may be curved. In particular, surfaces 198, 200 may be convex such that surfaces 198, 200 diverge away from one another at a decreasing rate moving from surface 196 towards surface 194. The inventors have determined that the use of side surfaces 198, 200 reduces the stress on body 38 proximate washers 40 even further relative to washer 40. Washer 184 may also include means, such as one or more fingers 208, for inhibiting rotation of washer 184 about axis 188. Fingers 208 extend axially from face 190 of washer 184. The fingers 208 may be similar in shape and arrangement to the fingers on washer 40 described above. As an alternative to fingers 208, other means for inhibiting rotation of washer 184 about axis 188 may again include fingers that are located on surface 196 of washer 184 and that are disposed radially inwardly of body 38 of disc 24 and aligned with body 38 of disc 24, a fastener (e.g., a pin) extending through washer 184 and disc 24, and a projection extending from one of disc 24 and washer 184 into a hole formed in the other of disc 24 and washer 184 wherein the projection and hole have complementary shapes that inhibit rotation (e.g., splines, a key/keyway or a D-shaped projection/hole).

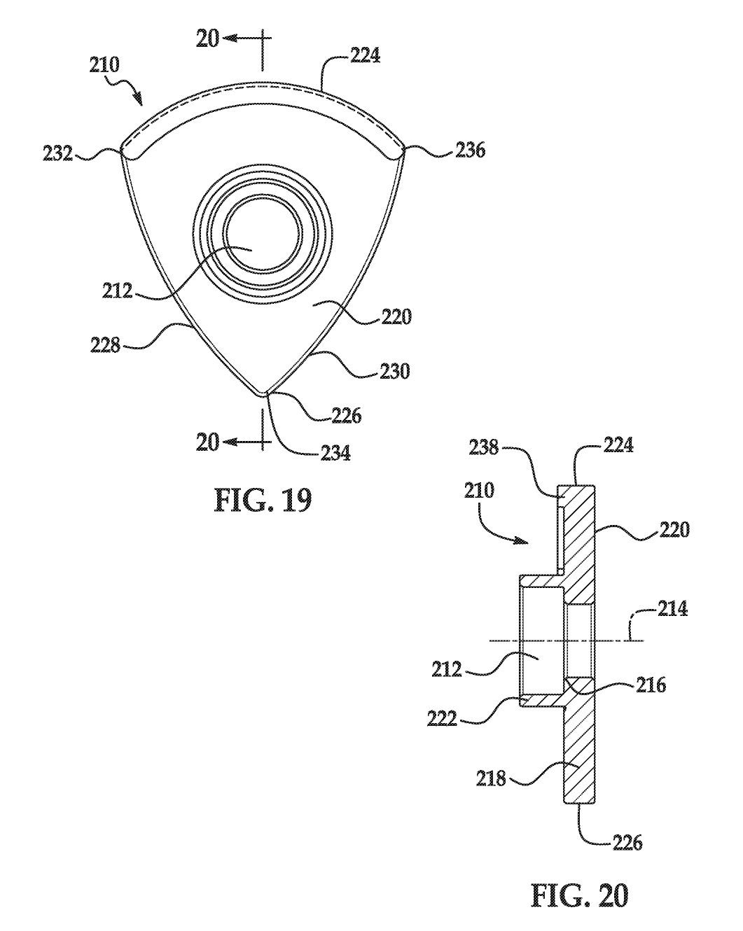

Referring now to FIGS. 19-20, washer 210 is configured for use with washer 184 as a mating set of washers. Washer 210 is disposed on an opposite side of body 38 of disc 24 relative to washer 184 and is aligned with washer 184. Washers 184, 210 receive a corresponding set of fasteners 26, 28. Washers 184, 210 alternate on each side of body 38 moving in a circumferential direction such that, on each side of body 38, each washer 184 is disposed circumferentially between two washers 210 and each washer 210 is disposed circumferentially between two washers 184. Washer 210 defines a bore 212 that is configured for alignment with one of fasteners holes 46, 48 and a corresponding bore 186 in washer 184. Bore 212 is disposed about an axis 214 that may extend substantially parallel to axis 36 upon assembly of coupling 20 and may be coincident with axis 188 upon assembly of coupling 20. Bore 212 is sized to receive fasteners 26, 28 therein. The inner diameter of bore 212 may vary to define a shoulder 216. Washer 210 includes one axial end face 218 that faces towards body 38 of disc 24 and another axial end face 220 that faces away from body 38. Washer 210 further defines an annular projection 222 extending from face 218 that is configured to extend through one of fastener holes 46, 48 and into bore 186 on washer 184. Washer 210 further includes a plurality of surfaces 224, 226, 228, 230 that extend between faces 218, 220 in directions substantially parallel to axis 214 and that are configured such that the width of washer 210 tapers moving from radially outer surface 224 to radially inner surface 226. Radially outer surface 224 may be curved and, in particular, convex. Radially inner surface 226 may be flat or substantially flat. It should be understood, however, that the shape of surfaces 224, 226 may vary. Side (or circumferential) surfaces 228, 230 extend between surfaces 224, 226 and define vertices 232, 234 and 236, 234, respectively, at the points of intersection with surfaces 224, 226. Surfaces 228, 230 may be curved. In particular, surfaces 228, 230 may be convex such that surfaces 228, 230 diverge away from one another at a decreasing rate moving from surface 226 towards surface 224. Washer 210 may also include means, such as one or more fingers 238, for inhibiting rotation of washer 210 about axis 214. Fingers 234 extend axially from face 218 of washer 210. The fingers 234 may be similar in shape and arrangement to the fingers on washer 42 described above. As an alternative to fingers 234, other means for inhibiting rotation of washer 210 about axis 218 may again include fingers that are located on surface 226 of washer 210 and that are disposed radially inwardly of body 38 of disc 24 and aligned with body 38 of disc 24, a fastener (e.g., a pin) extending through washer 210 and disc 24, and a projection extending from one of disc 24 and washer 210 into a hole formed in the other of disc 24 and washer 210 wherein the projection and hole have complementary shapes that inhibit rotation (e.g., splines, a key/keyway or a D-shaped projection/hole).

Referring again to FIGS. 1-2, fasteners 26, 28 are provided to couple disc 24 to flanges 32, 34 on spacer 22 and to the rotating bodies coupled by coupling 20. Fastener 26 may comprise a bolt or similar fastener with a head 240 and shank 242. Fastener 26 is configured to be inserted through washer 42 or 144 or 210, through fastener hole 46 or 48 in body 38 of disc 24, and through washer 40 or 116 or 184 such that head 240 abuts face 90 of washer 42 or face 154 of washer 144 or face 192 of washer 210 and shank 242 is disposed within a bore in fastener 28. Fastener 28 also includes a head 246 and an annular shank 248 defining a bore configured to receive shank 242 of fastener 26. Fastener 28 is configured to be inserted in the opposite direction relative to fastener 26 and, in particular, through a bore in one of mounting flanges 32, 34 on spacer 22 (or a bore in a hub or other element of the rotating body), through washer 40 or 116 or 184, through fastener hole 46 or 48 in body 38 of disc 24, and into projection 92 of washer 42 until it abuts shoulder 86 or projection 156 until it abuts shoulder 150 or projection 222 of washer 210 until it abuts shoulder 216. Fasteners 26, 28 may be coupled to one another through threads on shank 242 of fastener 26 and within shank 248 of fastener 28. It should be understood that the configuration of the fasteners may vary. As shown in FIG. 11, in an alternative embodiment, fasteners 26′, 28′ may comprise a bolt and nut, respectively, with mating threads.

A coupling 20 and a disc 24 for a coupling 20 in accordance with the present teachings are advantageous relative to conventional disc couplings and discs. In particular, the configuration of the washer 40, 42, 116, 144, 184, or 210 significantly reduces stress on the body 38 of the disc 24 that occurs during misalignment of the rotating bodies attached to the coupling 20 by better distributing the stress on the body 38 of the disc 24. As a result, the disc 24 is less likely to fail and the life of the disc 24 and coupling 20 are improved.

While the invention has been shown and described with reference to one or more particular embodiments thereof, it will be understood by those of skill in the art that various changes and modifications can be made without departing from the spirit and scope of the invention.

What is claimed is:

1. A disc for a disc coupling, comprising:
an annular body defining
a plurality of circumferentially spaced fastener holes, and,
a plurality of links, each link of the plurality of links extending between a pair of the plurality of circumferentially spaced fastener holes; and,
a washer defining a bore aligned with one of the plurality of circumferentially spaced fastener holes
wherein the washer includes a first face facing the body and a second face facing away from the body and a plurality of surfaces extending between the first and second faces, the plurality of surfaces including a radially outer surface, a radially inner surface, and first and second side surfaces extending between the radially inner and outer surfaces and defining vertices at intersections with the radially inner and outer surfaces.

2. The disc of claim 1 wherein a width of the washer tapers moving from the radially outer surface to the radially inner surface.

3. The disc of claim 1 wherein the first and second side surfaces are flat.

4. The disc of claim 1 wherein the first and second side surfaces are curved.

5. The disc of claim 4 wherein the first and second side surfaces are concave.

6. The disc of claim 4 wherein the first and second side surfaces are parabolic.

7. The disc of claim 4 wherein the first and second side surfaces are convex.

8. The disc of claim 1 wherein the washer defines an annular projection extending from the first face and extending through the one fastener hole.

9. The disc of claim 1 further comprising means for inhibiting rotation of the washer about an axis extending through the bore of the washer and the one fastener hole.

10. The disc of claim 1 wherein the washer includes a first finger extending axially from the first face, the first finger disposed radially outwardly of the body and radially aligned with the body.

11. The disc of claim 1 wherein the washer includes a second finger extending axially from the first face, the second finger disposed radially outwardly of the body and radially aligned with the body.

12. The disc of claim 11 wherein the first and second fingers have different circumferential lengths.

13. A disc coupling, comprising:
a spacer, and,
first and second discs coupled to opposite ends of the spacer, each of the first and second discs including
an annular body defining
a plurality of circumferentially spaced fastener holes, and,
a plurality of links, each link of the plurality of links extending between a pair of the plurality of circumferentially spaced fastener holes; and,
a washer defining a bore aligned with one of the plurality of circumferentially spaced fastener holes
wherein the washer includes a first face facing the body and a second face facing away from the body and a plurality of surfaces extending between the first and second faces, the plurality of surfaces including a radially outer surface, a radially inner surface, and first and second side surfaces extending between the radially inner and outer surfaces and defining vertices at intersections with the radially inner and outer surfaces.

14. The disc coupling of claim 12 wherein a width of the washer tapers moving from the radially outer surface to the radially inner surface.

15. The disc coupling of claim 12 wherein the first and second side surfaces are flat.

16. The disc coupling of claim 12 wherein the first and second side surfaces are curved.

17. The disc coupling of claim 15 wherein the first and second side surfaces are concave.

18. The disc coupling of claim 15 wherein the first and second side surfaces are parabolic.

19. The disc coupling of claim 15 wherein the first and second side surfaces are convex.

20. The disc coupling of claim 12 1 further comprising means for inhibiting rotation of the washer about an axis extending through the bore of the washer and the one fastener hole.
